(19) United States
(12) Patent Application Publication
(10) Pub. No.: US 2015/0379616 A1
(43) Pub. Date: Dec. 31, 2015

(54) WEARABLE COMPUTING DEVICE GIFT REGISTRY SYSTEM

(71) Applicant: TARGET BRANDS INC., Minneapolis, MN (US)

(72) Inventor: Annie CLEVELAND, Minneapolis, MN (US)

(21) Appl. No.: 14/752,000

(22) Filed: Jun. 26, 2015

Related U.S. Application Data
(60) Provisional application No. 62/019,138, filed on Jun. 30, 2014.

(51) Int. Cl. G06Q 30/06

(52) U.S. Cl. CPC G06Q 30/0633

(57) ABSTRACT

Gift registry systems, user interfaces, and methods are described that provide a registry owner a way to complete a gift registry. The method includes providing an application for a wearable computing device, the wearable computing device having a camera and a display, the application permitting a user to capture an image of one of a product and a product advertisement using the camera of the wearable computing device. The method includes receiving a captured image from the wearable computing device and identifying the product from the captured image. The method further includes generating a user interface for displaying details about the product from the captured image and providing the user interface for display on the wearable computing device.

### BACKGROUND

Consumers purchase products in retail stores and via retail websites accessible from the Internet. Shopping at a retail store sometimes allows a shopper a chance to see, sample, or use a product the consumer is contemplating purchasing. Shopping via a retail website allows consumers to interact with pictures, videos, and/or audio clips relating to the products the consumer is contemplating purchasing. Often, shopping via the retail website allows the consumer to view reviews by other consumers, search for related products, search for products that other consumers bought at the same time, or the like. In some instances, the inventory of products available from a retailer through the retail website can be different from the products available at the retail store.

Improved ways to enhance a consumer's shopping experience are desirable.

### SUMMARY

Gift registry systems, user interfaces, and methods are described that provide a registry owner a way to complete a gift registry in a retail store while having the accessibility of a personalized shopping experience.

In one embodiment, a registry owner wearing a wearable computing device in a retail store can capture an image of a product using an application that resides on the wearable computing device. In another embodiment, the registry owner wearing the wearable computing device in the retail store can capture an image of identifying information of a product (e.g., a barcode, or the like).

In one embodiment, the wearable computing device can enhance a shopping experience in a retail store in which the registry owner is registering for a gift registry such as, but not limited to, a wedding registry, a baby registry, or the like.

In one embodiment, the registry owner wearing the wearable computing device in the retail store can read reviews on a display of the wearable computing device of a product she is considering while in the retail store. In one embodiment, the registry owner can add her own review or other comments related to the product using the wearable computing device.

In one embodiment, the registry owner wearing the wearable computing device in the retail store can capture an image of a product in the retail store with a camera of the wearable computing device to identify additional options, such as but not limited to, additional colors, sizes, or the like, that would be available if the product were purchased through the retail website of the retailer instead of in the retail store.

In one embodiment, the registry owner wearing the wearable computing device in the retail store can capture an image of a product identifier in the retail store using the camera of the wearable computing device, such as a product label on a shelf, to view the product through the retail website of the retailer even when the retail store does not have any of the product in stock.

In one embodiment, the registry owner wearing the wearable computing device in the retail store can capture an image of a product using the camera of the wearable computing device and share product information with one or more people. In one embodiment, the registry owner can share the product information via a social network.

In one embodiment, the registry owner wearing the wearable computing device in the retail store can capture an image of a product or products from an advertisement that is located in the retail store using the camera of the wearable computing device. The captured image of the product can be used to identify a location in the retail store in which the product can be found. In another embodiment, the captured image of the product can be used to obtain additional information about the product without requiring the registry owner to go to the product's location in the retail store.

In one embodiment, the registry owner's wearing of the wearable computing device in the retail store can additionally signal to employees an individual or individuals that are preparing a gift registry.

A method includes providing an application for a wearable computing device, the wearable computing device having a camera and a display, the application permitting a user to capture an image of one of a product and a product advertisement using the camera of the wearable computing device. The method includes receiving a captured image from the wearable computing device and identifying the product from the captured image. The method further includes generating a user interface for displaying details about the product from the captured image and providing the user interface for display on the wearable computing device.

A system includes an application that is loadable onto a wearable computing device, the wearable computing device including a camera and a display, and that when loaded onto the wearable computing device permits the wearable computing device to capture one of a product image and a product advertisement using the camera, communicate with a server to send to the server a captured image and to receive from the server product information, and to cause display of the product information on the display. The server is able to communicate with the wearable computing device and configured to receive the captured image from the wearable computing device, identify the product information, and send the product information to the application. The product information include at least two of the captured image, a product details option, a specifications option, a reviews option, a similar products option, an add-on products option, a share with others option, and a reminder.

A method includes providing a wearable computing device in a retail store, the wearable computing device including an application configured for a user to prepare a list of products for purchase. The method further includes adding a product to the list using the wearable computing device.

### BRIEF DESCRIPTION OF THE DRAWINGS

References are made to the accompanying drawings that form a part of this disclosure, and which illustrate embodiments in which the systems and methods described in this specification can be practiced.

FIG. 1 is a schematic diagram of a system for implementing a gift registry as described herein, according to an embodiment.

FIG. 2A illustrates a registry owner's view when using a gift registry system as described herein, according to an embodiment.

FIG. 2B is a schematic diagram of a user interface for a wearable computing device of a gift registry system as described herein, according to an embodiment.

FIG. 3 illustrates a flowchart of a process for creating a gift registry using a gift registry system as described herein, according to an embodiment.

FIG. 4 illustrates a flowchart of a recommendation process for a gift registry using a gift registry system as described herein, according to an embodiment.

FIG. 5 is a schematic diagram of an architecture for a computing device, according to an embodiment.

Like reference numbers represent like parts throughout.

### DETAILED DESCRIPTION

Gift registry systems, user interfaces, and methods are described that provide a registry owner a way to complete a gift registry in a retail store while having the accessibility of a personalized shopping experience.

An individual who would like to prepare a gift registry can do so at a retail store. Upon entering the retail store, the individual can receive a wearable computing device from an employee (e.g., a guest services employee) of the retail store. The wearable computing device is configured with an application for facilitating preparation of a gift registry. The individual, who is now the registry owner, can place the wearable computing device on her head and traverse the store. As the registry owner identifies a product she would like to add to the gift registry, she can provide an input (e.g., a voice command, or the like) to the wearable computing device that she is wearing and the product can be added to the gift registry.

In one embodiment, a registry owner wears the wearable computing device while performing the methods described herein.

In one embodiment, the registry owner wearing a wearable computing device uses a camera of the wearable computing device to capture an image of a product in a retail store using an application that resides on the wearable computing device. In another embodiment, the registry owner uses the camera on the wearable computing device to capture an image of a product identifier (e.g., a barcode, watermark, or the like). The image of the product or product identifier is then recognized. A variety of product information resulting from the image recognition is then displayed on a display of the wearable computing device. The product information can include, for example, but is not limited to, product specifications, reviews of the product, similar products, add-on products, or the like. In some embodiments, the registry owner can share the product information (e.g., via one or more social networks, directly to another user device, or the like). The product information can alternatively be referred to as product details.

In one embodiment, the product information returned to the registry owner includes options to identify products that are available only via a retailer's website and are not available in the retail store.

In one embodiment, the registry owner receives recommendations based on the product selected. For example, the recommendations can indicate other products that were purchased by consumers who viewed the product from the captured image.

A wearable computing device, as used herein, generally refers to any computing device that is wearable by an individual. More particularly, a wearable computing device generally includes a display (e.g., an optical head-mounted display) and at least a camera and a means for controlling the camera. Suitable wearable computing devices are, for example, available from Google Inc. The wearable computing device can be a head-wearable computing device.

A head-wearable computing device, as used herein, generally refers to a wearable computing device that is designed to be worn on a person's head. The head-wearable computing device can be in a form of glasses, or wearable similar to glasses, a hat or visor including a computing device and a display visible to the individual, a helmet including a computing device and a display, or other similar computing device that the individual can wear and operate in a hands-free or substantially hands-free manner.

The camera on the wearable computing device is generally capable of capturing a photograph and/or video. Accordingly, capturing an image, as used herein, can include capturing a photograph or a video. Any type of image capture technology on a wearable computing device that is capable of capturing an image of a product and/or a product advertisement can be used.

Capturing an image of a product and/or capturing an image of a product advertisement, as used herein, generally refers to obtaining an image of a product or product advertisement using the camera or other image capturing technology of the wearable computing device. The image that is captured may be referred to as the captured image, the captured product image, or the like. It is to be appreciated that capturing an image of a product can include capturing an image of the product itself or capturing an image of a product identifier such as, but not limited to, a barcode, a QR code, a watermark, or the like.

The term scan or scanning using a wearable computing device may also be used to refer to the use of a camera on a wearable computing device to capture a photograph or video of a barcode or a QR code on a product or in a product advertisement in order to read the barcode or QR code. Therefore, to capture or capturing the image of the product or the product advertisement using a camera of the wearable computing device can also be referred to using the term scan or scanning the product or product advertisement and the captured image can also be referred to as a scanned image.

A gift registry, as used herein, generally refers to a wish list of products. In one embodiment, a wish list of products can be the same as or similar to a shopping list of products. A gift registry can be used for any variety of important events. Examples of gift registries include, but are not limited to, a wedding registry, a baby registry, a college registry, an anniversary registry, a first home registry, or the like. A gift registry is generally made publicly available, or semi-publicly available (e.g., only to family and/or friends of a registrant). A gift registry is often managed by a retail store, such that a registry owner creates a wish list of products that family and friends can then purchase. The registry owner may also be able to purchase products from the gift registry. The registry owner and all parties with access to the gift registry can view what has and what has not been purchased from the list. The registry owner, however, cannot see who has purchased the item.

A registry owner, as used herein, is a consumer who compiles a gift registry.

An augmented reality device, as used herein, is a device including a direct or indirect view of a real-world environment as supplemented by computer-generated outputs such as, but not limited to, sounds, video, graphics, location data, or the like.

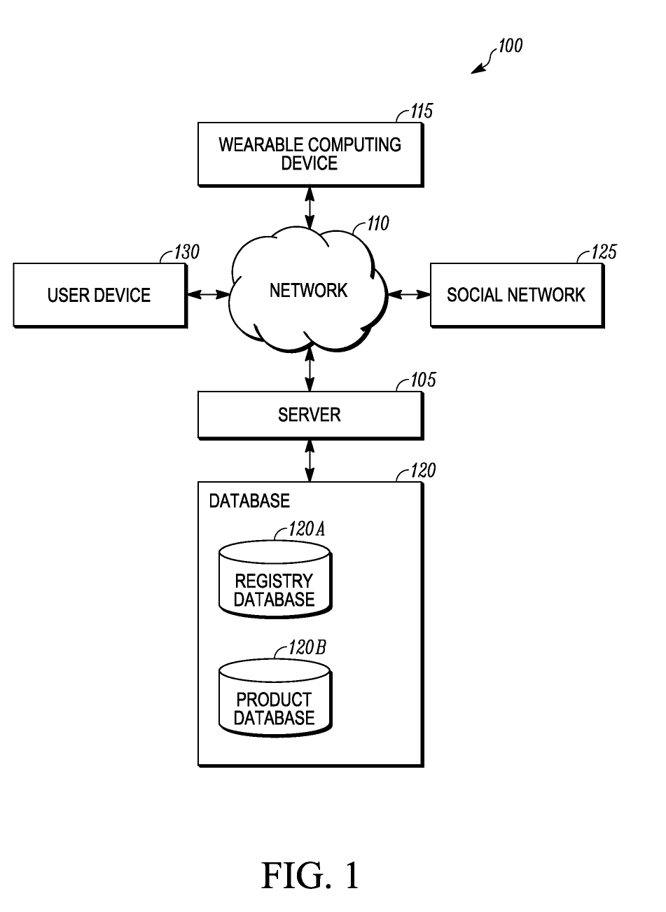

FIG. 1 is a schematic diagram of an embodiment of a gift registry system 100 for implementing the user interfaces, systems, and methods described herein. In the gift registry system 100, a server 105 is connected in communication with a wearable computing device 115 via a network 110.

An application can be loaded onto the wearable computing device 115 that permits the wearable computing device 115 to capture an image of a product and/or capture an image of a product advertisement using a camera and provide the captured image to the server 105 via the network 110. In some embodiments, the wearable computing device 115 can communicate the captured image with one or more social networks 125 and/or one or more user devices 130 via the network 110. The wearable computing device 115 can receive product information from the server 105.

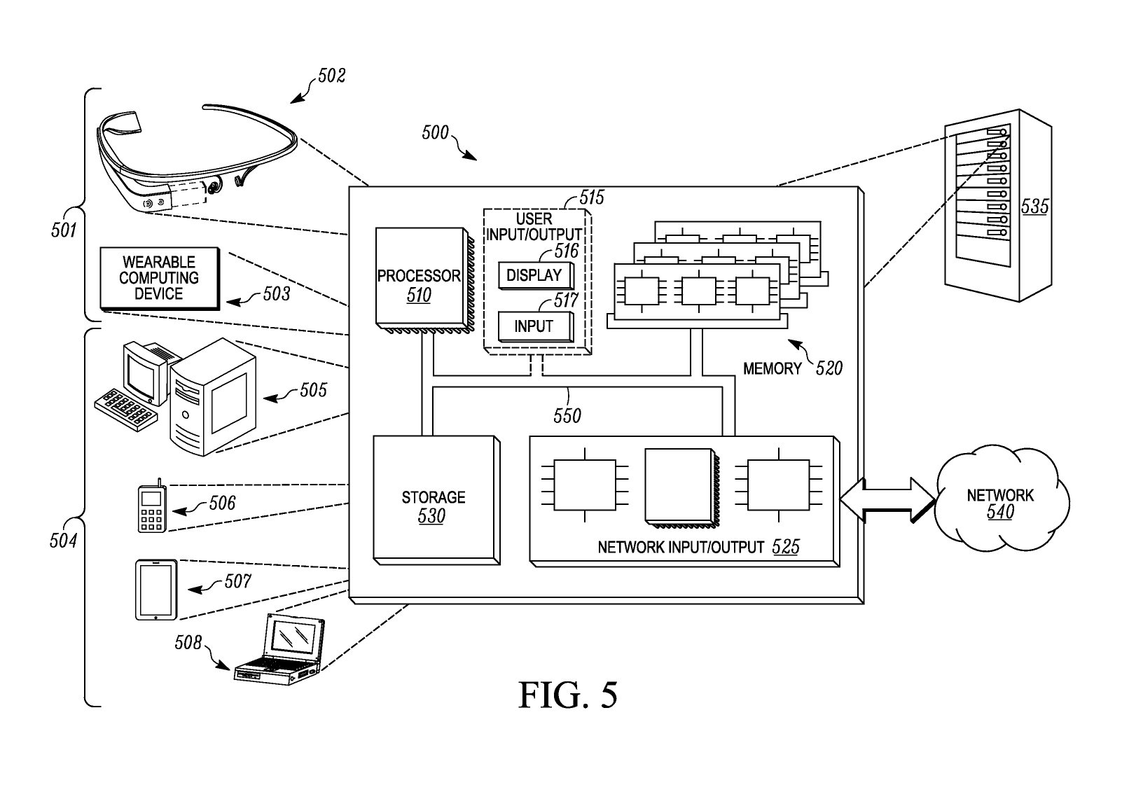

The server 105 can make a graphical user interface (GUI) available to the wearable computing device 115. The server 105 makes the GUI available over the network 110 according to principles known in the art suitable for allowing a user to access and view the GUI with the wearable computing device 115. In some embodiments, aspects of the server 105 are the same as or similar to aspects of a server device 535 as described in accordance with FIG. 5 below. It is to be appreciated that the application loaded onto the wearable computing device 115 can include one or more features of the server 105. For example, the application can make the GUI available to the wearable computing device 115 in some embodiments. Further, in some embodiments, the application can include a database of products, information about a retail store (e.g., a map, hours of operation, etc.), or the like, such that the information does not need to be obtained over the network 110 from the server 105.

The network 110 is generally representative of the Internet. The network 110 can include, for example, a local area network, a wide area network, a wireless network, a cellular data network, or the like. In some embodiments, aspects of the network 110 can be the same as or similar to aspects of a network 540 as described in accordance with FIG. 5 below.

The server 105 is in communication with a database 120. The database 120 generally includes a variety of information on products available through the retail store and products available via the retail website. The database 120 also includes information related to specific shopping experiences, such as a gift registry database 120A. The gift registry database 120A can, for example, include information about a registry owner's gift registry, including what products are on the gift registry, what products have been purchased from the gift registry, or the like. The database 120 also includes a product database 120B. The product database 120B stores product information about the various products offered for sale by the retailer. Examples of product information about the various products includes, but is not limited to, pricing details, product options, product images, related products, or the like.

The server 105 can be in communication with the social network 125 via the network 110. In some embodiments, the social network 125 can include reviews for a product that is in the product database 120B. The server 105 can make these product reviews available to the GUI on the wearable computing device 115 such that the GUI can provide reviews of a product to the registry owner who is wearing the wearable computing device 115. Examples of the social network 125 include, but are not limited to, Google+, Pinterest, Facebook, Instagram, Twitter, or the like.

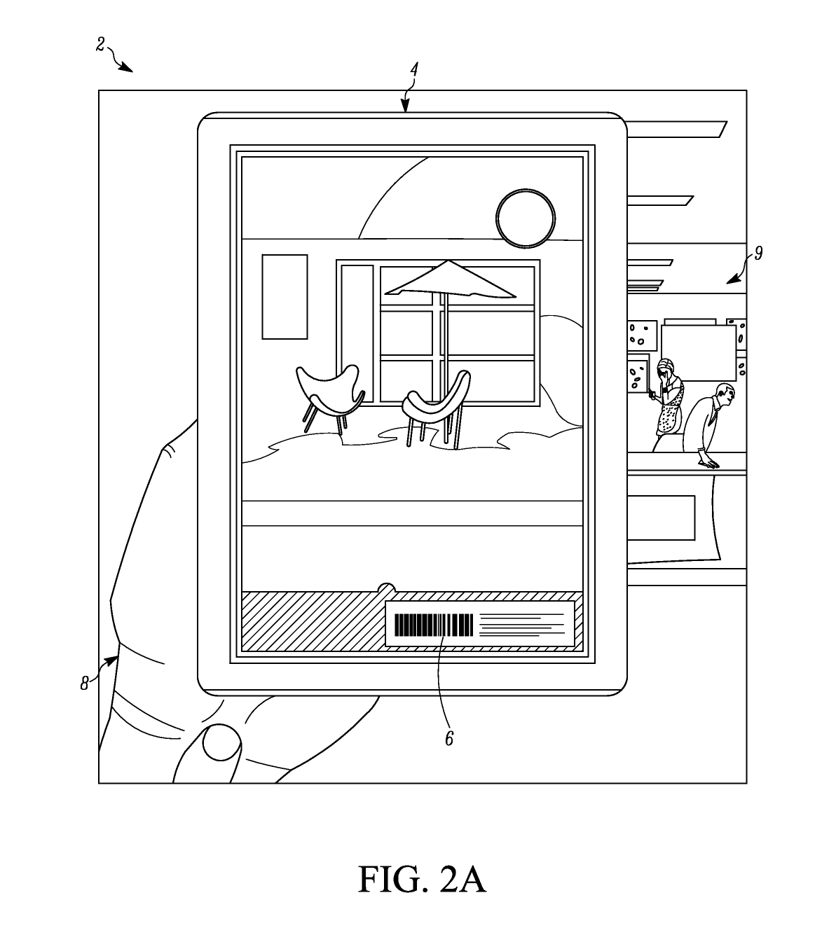

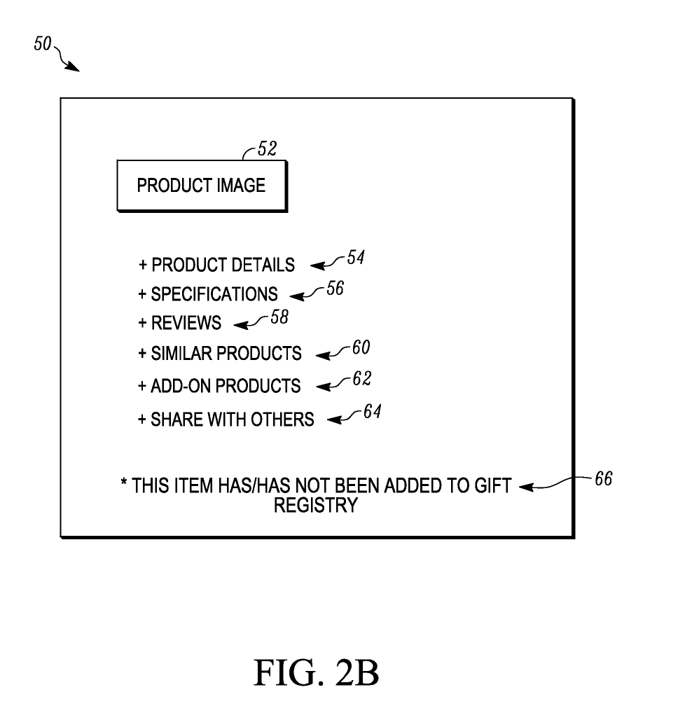

FIG. 2A illustrates a registry owner's view 2 when using the gift registry system 100 as described herein in a retail store. In the view 2, the registry owner 8 is holding a picture frame 4. The picture frame 4 includes an illustration and a product label having a barcode 6. The registry owner's view 2 includes additional shoppers and store features in the background 9. As described herein, the registry owner 8 can identify the picture frame 4 as a product the registry owner 8 is interested in adding to her gift registry, according to some embodiments. The registry owner 8 is wearing the wearable computing device 115 (FIG. 1) that includes a camera which can capture an image of the picture frame 4. If the registry owner 8 indicates to the wearable computing device 115 (e.g., by voice command, or the like) that she would like to add the picture frame 4 to her gift registry, she can capture an image of the picture frame 4. Once the registry owner 8 has indicated that she would like to add the picture frame 4 to her gift registry, the application can display a user interface 50 (described in further detail in accordance with FIG. 2B below) featuring additional details about the product. In some embodiments, the wearable computing device 115 can be used to capture an image of the barcode 6 in order to obtain additional details about the product instead of capturing an image of the entire product.

In some embodiments, the wearable computing device 115 can additionally be configured as an augmented reality device. In such embodiments, a display of the wearable computing device 115 can be used to display a real-time video feed of the retail store as the registry owner 8 is seeing it. The display can be supplemented by computer-generated outputs. For example, if the registry owner 8 indicates that she would like to add the picture frame 4 to her registry, or even just learn additional details about the picture frame 4, the wearable computing device 115 can capture an image and then supplement the display such that a price of the picture frame 4 is overlaid on the picture frame 4 within the display of the wearable computing device 115 for the registry owner 8.

In another embodiment, the wearable computing device 115 can be configured to generate a sound output, a visual indicator, or the like, when the registry owner 8 is in the vicinity of a product that she has indicated is of interest. For example, if the registry owner 8 indicates a preference prior to beginning her gift registering that her favorite sport is soccer, she may receive an indication (e.g., sound output, a visual indicator, or the like) from the wearable computing device 115 when she is near soccer balls, soccer cleats, soccer jerseys, or the like.

FIG. 2B is a schematic diagram of the user interface 50 for a wearable computing device as described herein. The user interface 50 of FIG. 2B is generally displayed on a display of the wearable computing device 115 (FIG. 1).

The user interface 50 includes a product image 52. The product image 52 is generally representative of a product the registry owner has selected for consideration. In some embodiments, the product image 52 can be displayed to the registry owner even if the product is not currently available in the retail store. For example, the registry owner can identify a product label having no stock on the retail store's shelves that she is interested in adding to the gift registry. In such a scenario, the identifying information about the product from the product label can be used to display the product image 52 to the registry owner.

The user interface 50 includes a variety of additional options 54-64 for the registry owner. The registry owner can select a product details option 54 to learn additional information about the product. For example, the product details option 54 can include a general overview of the product, information about what is included with the product when purchased, information about what is sold separately, or the like.

The registry owner can select a specifications option 56 to learn the more detailed specifications of the product. For example, if the product is an item of furniture, the specifications can include information such as the color, the materials used to make the product, the dimensions, or the like.

The registry owner can select a reviews option 58 in order to read reviews of the product. In some embodiments, the reviews displayed when the reviews option 58 is selected can be divided into categories by the party who is doing the reviewing. Examples of categories include, but are not limited to, expert reviews, other consumer reviews, or the like.

The registry owner can select a similar products option 60 in order to see products similar to that selected. For example, if a stereo produced by Manufacturer A is the product selected, the registry owner may be able to see stereos produced by Manufacturers B-D when the similar products option 60 is selected.

The user interface 50 further includes an add-on products option 62. The add-on products option 62 can be selected by the registry owner in order to see products that are complementary to the product selected. For example, continuing with the stereo example, the add-on products option 62, if selected, can identify one or more products, such as speakers, speaker wires, other audio cables, or the like, that can complete a stereo system.

The user interface 50 includes a share with others option 64. The share with others option 64 can be used to share the product information with other consumers via one or more social networks 125 (FIG. 1). In another embodiment, the share with others option 64 can be used to share the product information with another user device 130 (FIG. 1). Continuing with the stereo example, a registry owner may select a stereo, but be uncertain whether this is the best stereo for her. The registry owner can use the share with others option 64 to, for example, provide product information about the stereo to another user device 130, such as a mobile phone, and can receive feedback before adding the stereo to the gift registry. In some embodiments, this interaction with other user devices 130 can enhance the registry owner's shopping experience by providing the effect of shopping directly with another person.

The user interface 50 also includes a reminder 66. The reminder 66 can provide an indication to the registry owner that she has added the product to her gift registry. Alternatively, the reminder 66 can provide an indication to the registry owner that she has not added the product to her gift registry. In some embodiments, there may be one or more additional options, such as the ability to modify the quantity of products requested on the gift registry if the reminder 66 indicates that the registry owner has already added the product to her gift registry. The registry owner may be able to modify options other than the quantity as well. For example, the registry owner may be able to modify a color, a size, or other similar options.

The user interface 50 can include one or more additional configurations in which the registry owner in the retail store is also able to identify products from the retail website of the retailer. Examples of additional user interfaces that can be displayed on wearable computing device 115 are described, for example, in U.S. application Ser. No. 14/305,326 and U.S. application Ser. No. 14/140,901, which are incorporated herein by reference in their entirety.

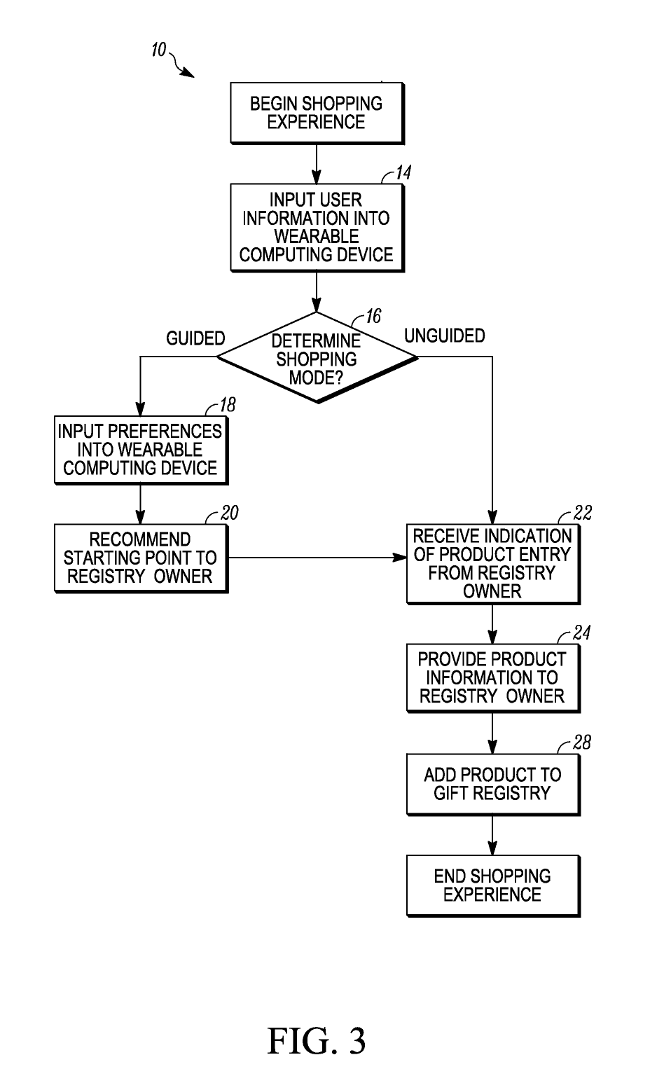

FIG. 3 illustrates a flowchart of a process 10 for creating a gift registry using the gift registry system 100 (FIG. 1) as described herein. It is to be appreciated that completing a gift registry is an example of a particular shopping experience. In some embodiments, the process 10 does not require a registry owner to be completing a gift registry. The process 10 can alternatively be completed by a consumer generally browsing a retail store for one or more products that can be added to a shopping list.

The process 10 begins when a registry owner in a retail store indicates that she would like to begin the shopping experience. At 14 the registry owner inputs user information into the wearable computing device 115 (FIG. 1). The user information can be input into the wearable computing device 115 using, for example, voice commands, gestures, or the like. Examples of user information that may be input at 14 include, but are not limited to, identifying personal information (e.g., first and last name, telephone number, email address, retail website account username, or the like), type of gift registry (e.g., wedding, baby, anniversary, or the like), or the like.

The gift registry system 100 includes at least two modes of shopping. A first mode, a guided mode, may direct the registry owner to locations throughout the retail store based on various preferences of the registry owner. A second mode, an unguided mode, can allow the registry owner to browse through the retail store in much the same way she would without the wearable computing device 115. At 16, the registry owner indicates whether she would like to shop using the guided mode or the unguided mode. If the registry owner would like to use the unguided mode the process 10 continues to 22. If the registry owner would like to use the guided mode, she then inputs preferences at 18 into the wearable computing device 115. Examples of preferences the user can input include, but are not limited to, a stage in life (e.g., going to college, getting married, having a baby, or the like), a lifestyle (e.g., outdoor-lover, sports enthusiast, or the like), a personal style (e.g., modern, shabby chic, or similar design style), brand preferences, or the like. Based on the preferences input at 18, the gift registry system provides a recommended starting point to the registry owner at 20. The recommended starting point can be a general section in the retail store, according to some embodiments. In other embodiments, the gift registry system can include (or have access to) a map of the retail store and indicate to the registry owner that she should, for example begin her shopping experience at an aisle that includes products which may be of interest based on her preferences.

In either mode, guided or unguided, at 22 the wearable computing device 115 receives an indication from the registry owner that she would like to enter a product. The indication can be a combination of, for example, a voice command and directing a camera or other image-capturing device of the wearable computing device 115 toward the product. The wearable computing device 115 can then capture an image of the product and provide product information to the registry owner at 24. At 24, providing product information to the registry owner can include presenting the user interface 50 on the display of the wearable computing device 115.

At 28 the registry owner can indicate that she would like to add the product to her gift registry, and the product will accordingly be added to the gift registry. The process 10 can be repeated until the registry owner is finished with her gift registry. When the registry owner adds the product to her gift registry, she may be presented with one or more configuration options. For example, the configuration options can include, but are not limited to, selecting a color, a size, or the like. In some embodiments, the configuration options can include a comments section, in which the registry owner can enter her comments about the product. The registry owner can choose to add comments about why she chose a specific product, why she chose a specific color, or the like.

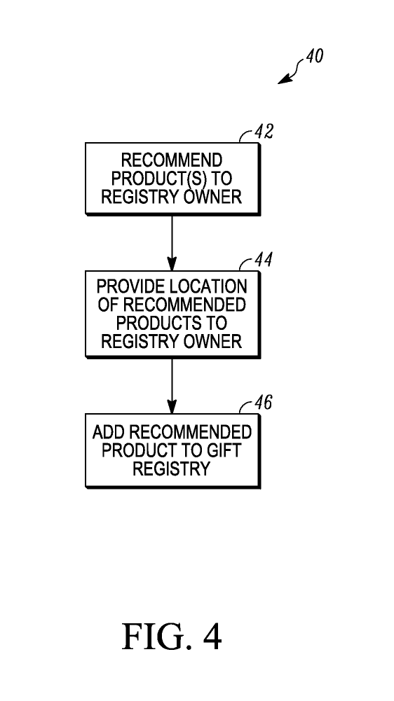

FIG. 4 illustrates a flowchart of a recommendation process 40 for a gift registry using a gift registry system as described herein. The process 40 can be part of the process 10 in some embodiments. For example, the process 40 can be executed following 28 as described above. The process 40 generally includes providing a recommendation to a registry owner based on the product or products she has selected for adding to her gift registry. At 42 one or more products are recommended to the registry owner based on the product that was added at 28 in FIG. 3. The recommended product from 42 can be identified by location in the retail store to the registry owner at 44. In some embodiments, the recommended product at 42 may not be available in the store. In such embodiments, the registry owner can review the recommended product on the display of the wearable computing device 115 and add the recommended product to the gift registry at 46. In other embodiments, even when the recommended product is available in the retail store, the registry owner can add the recommended product to the gift registry at 46 without traversing the store to find the product.

FIG. 5 is a schematic diagram of an architecture for a computer device 500. The computer device 500 and any of the individual components thereof can be used for any of the operations described in accordance with any of the computer-implemented methods described herein.

The computer device 500 generally includes a processor 510, memory 520, a network input/output (I/O) 525, storage 530, and an interconnect 550. The computer device 500 can optionally include a user I/O 515, according to some embodiments. The computer device 500 can be in communication with one or more additional computer devices 500 through a network 540.

The computer device 500 is generally representative of hardware aspects of a variety of wearable computing devices 501, a variety of user devices 504, and a server device 535. The illustrated wearable computing devices 501 and user devices 504 are examples and are not intended to be limiting. Examples of the wearable computing devices 501 include, but are not limited to, glasses 502, or other head-wearable computing devices 503 as described herein. It is to be appreciated that the glasses 502 may not have lenses in the manner that conventional glasses do. However, in some embodiments, the glasses 502 can additionally include lenses (prescription or non-prescription). Examples of the user devices 504 include, but are not limited to, a desktop computer 505, a cellular/mobile phone 506, a tablet device 507, and a laptop computer 508. It is to be appreciated that the user devices 504 can include other devices such as, but not limited to, a personal digital assistant (PDA), a video game console, a television, or the like. In some embodiments, the devices 501, 504 can alternatively be referred to as client devices 501, 504. In such embodiments, the client devices 501, 504 can be in communication with the server device 535 through the network 540. One or more of the client devices 501, 504 can be in communication with another of the client devices 501, 504 through the network 540, according to some embodiments.

The processor 510 can retrieve and execute programming instructions stored in the memory 520 and/or the storage 530. The processor 510 can also store and retrieve application data residing in the memory 520. The interconnect 550 is used to transmit programming instructions and/or application data between the processor 510, the user I/O 515, the memory 520, the storage 530, and the network I/O 540. The interconnect 550 can, for example, be one or more busses or the like. The processor 510 can be a single processor, multiple processors, or a single processor having multiple processing cores. In some embodiments, the processor 510 can be a single-threaded processor. In some embodiments, the processor 510 can be a multi-threaded processor.

The user I/O 515 can include a display 516 and/or an input 517, according to some embodiments. It is to be appreciated that the user I/O 515 can be one or more devices connected in communication with the computer device 500 that are physically separate from the computer device 500. For example, the display 516 and input 517 for the desktop computer 502 can be connected in communication but be physically separate from the computer device 500. In some embodiments, the display 516 and input 517 can be physically included with the computer device 500 for the desktop computer 505. In some embodiments, the user I/O 515 can physically be part of the device 501, 504. For example, wearable computing device 502, 503, the cellular/mobile phone 506, the tablet device 507, and the laptop 508 include the display 516 and input 517 that are part of the computer device 500. The server device 535 generally may not include the user I/O 515. In some embodiments, the server device 535 can be connected to the display 516 and input 517.

The display 516 can include any of a variety of display devices suitable for displaying information to the user. Examples of devices suitable for the display 516 include, but are not limited to, a cathode ray tube (CRT) monitor, a liquid crystal display (LCD) monitor, a light emitting diode (LED) monitor, an optical head-mounted display, or the like.

The input 517 can include any of a variety of input devices or means suitable for receiving an input from the user. Examples of devices suitable for the input 517 include, but are not limited to, a keyboard, a mouse, a trackball, a button, a voice command, a proximity sensor, an ocular sensing device for determining an input based on eye movements (e.g., scrolling based on an eye movement), or the like. It is to be appreciated that combinations of the foregoing inputs 517 can be included for the devices 501, 504. In some embodiments the input 517 can be integrated with the display 516 such that both input and output are performed by the display 516.

The memory 520 is generally included to be representative of a random access memory such as, but not limited to, Static Random Access Memory (SRAM), Dynamic Random Access Memory (DRAM), or Flash. In some embodiments, the memory 520 can be a volatile memory. In some embodiments, the memory 520 can be a non-volatile memory. In some embodiments, at least a portion of the memory can be virtual memory.

The storage 530 is generally included to be representative of a non-volatile memory such as, but not limited to, a hard disk drive, a solid state device, removable memory cards, optical storage, flash memory devices, network attached storage (NAS), or connections to storage area network (SAN) devices, or other similar devices that may store non-volatile data. In some embodiments, the storage 530 is a computer readable medium. In some embodiments, the storage 530 can include storage that is external to the computer device 500, such as in a cloud.

The network I/O 525 is configured to transmit data via a network 540. The network 540 may alternatively be referred to as the communications network 540. Examples of the network 540 include, but are not limited to, a local area network (LAN), a wide area network (WAN), the Internet, or the like. In some embodiments, the network I/O 525 can transmit data via the network 540 through a wireless connection using WiFi, Bluetooth, or other similar wireless communication protocols. In some embodiments, the computer device 500 can transmit data via the network 540 through a cellular, 3G, 4G, or other wireless protocol. In some embodiments, the network I/O 525 can transmit data via a wire line, an optical fiber cable, or the like. It is to be appreciated that the network I/O 525 can communicate through the network 540 through suitable combinations of the preceding wired and wireless communication methods.

The server device 535 is generally representative of a computer device 500 that can, for example, respond to requests received via the network 540 to provide, for example, data for rendering a website or GUI on the devices 501, 504. The server 535 can be representative of a data server, an application server, an Internet server, or the like.

Aspects described herein can be embodied as a system, method, or computer readable medium. In some embodiments, the aspects described can be implemented in hardware, software (including firmware or the like), or combinations thereof. Some aspects can be implemented in a non-transitory, tangible computer readable medium, including computer readable instructions for execution by a processor. Any combination of one or more computer readable medium(s) can be used.

The computer readable medium can include a computer readable signal medium and/or a computer readable storage medium. A computer readable storage medium can include any tangible medium capable of storing a computer program for use by a programmable processor to perform functions described herein by operating on input data and generating an output. A computer program is a set of instructions that can be used, directly or indirectly, in a computer system to perform a certain function or determine a certain result. Examples of computer readable storage media include, but are not limited to, a floppy disk; a hard disk; a random access memory (RAM); a read-only memory (ROM); a semiconductor memory device such as, but not limited to, an erasable programmable read-only memory (EPROM), an electrically erasable programmable read-only memory (EEPROM), Flash memory, or the like; a portable compact disk read-only memory (CD-ROM); an optical storage device; a magnetic storage device; other similar device; or suitable combinations of the foregoing. A computer readable signal medium can include a propagated data signal having computer readable instructions. Examples of propagated signals include, but are not limited to, an optical propagated signal, an electro-magnetic propagated signal, or the like. A computer readable signal medium can include any computer readable medium that is not a computer readable storage medium that can propagate a computer program for use by a programmable processor to perform functions described herein by operating on input data and generating an output.

Some embodiments can be provided to an end-user through a cloud-computing infrastructure. Cloud computing generally includes the provision of scalable computing resources as a service over a network (e.g., the Internet or the like).

The terminology used herein is intended to describe particular embodiments and is not intended to be limiting. The terms “a,” “an,” and “the” include the plural forms as well, unless clearly indicated otherwise. The terms “comprises” and/or “comprising,” when used in this Specification, specify the presence of the stated features, integers, steps, operations, elements, and/or components, but do not preclude the presence or addition of one or more other features, integers, steps, operations, elements, and/or components.

With regard to the preceding description, it is to be understood that changes may be made in detail, especially in matters of the construction materials employed and the shape, size, and arrangement of parts without departing from the scope of the present disclosure. This Specification and the embodiments described are examples only, with the true scope and spirit of the disclosure being indicated by the claims that follow.

What is claimed is:

1. A method for facilitating preparation of a gift registry, comprising:
providing an application for a wearable computing device, the wearable computing device having a camera and a display, the application permitting a user to capture an image of one of a product and a product advertisement using the camera of the wearable computing device;
receiving a captured image from the wearable computing device;
identifying the product from the captured image;
generating a user interface for displaying details about the product from the captured image; and
providing the user interface for display on the wearable computing device.

2. The method according to claim 1, further comprising:
receiving a user command indicating the product is to be added to the gift registry; and
adding the product to the gift registry.

3. The method according to claim 1, wherein the details about the product include details about options for the product available in a retail store and via a retail website.

4. The method according to claim 1, further comprising:
recommending another product for purchase, wherein the recommending is based on the product captured by the user.

5. The method according to claim 1, wherein displaying details about the product includes displaying two or more of the captured image, a product details option, a specifications option, a reviews option, a similar products option, an add-on products option, a share with others option, and a reminder.

6. The method according to claim 1, wherein the captured image is an image of a barcode for the product.

7. The method according to claim 5, wherein displaying the details includes displaying details about products that are not in stock in a retail store.

8. The method according to claim 1, further comprising receiving feedback from a user device or a social network.

9. A gift registry system, comprising:
an application that is loadable onto a wearable computing device, the wearable computing device including a camera and a display, and that when loaded onto the wearable computing device permits the wearable computing device to capture one of a product image and a product advertisement using the camera, communicate with a server to send to the server a captured image and to receive from the server product information, and to cause display of the product information on the display;
the server able to communicate with the wearable computing device and configured to receive the captured image from the wearable computing device, identify the product information, and send the product information to the application,
wherein the product information include at least two of the captured image, a product details option, a specifications option, a reviews option, a similar products option, an add-on products option, a share with others option, and a reminder.

10. The gift registry system according to claim 9, wherein the application is further configured to permit a registry owner to add a product represented by the product image to a gift registry.

11. The gift registry system according to claim 9, wherein the product information includes options available in a retail store and options available through a retail website.

12. The gift registry system according to claim 9, the server further configured to:
identify one or more similar products based on the product information; and
send a recommendation to the application that includes the one or more similar products.

13. The gift registry system according to claim 12, wherein the recommendation includes product information associated with the one or more similar products.

14. The gift registry system according to claim 13, wherein the recommendation includes a location within a retail store at which the one or more similar products are located.

15. The gift registry system according to claim 9, wherein the wearable computing device is a head-wearable computing device.

16. A method, comprising:
providing a wearable computing device in a retail store, the wearable computing device including an application configured for a user to prepare a list of products for purchase; and
adding a product to the list using the wearable computing device.

17. The method according to claim 16, wherein the wearable computing device is a head-wearable computing device.

18. The method according to claim 16, wherein the list is a gift registry.

19. The method according to claim 16, wherein adding a product to the list includes capturing an image of the product.

20. The method according to claim 16, further comprising:
providing a recommendation for adding another product to the list based on the product.
